(19) United States
(12) Patent Application Publication
(10) Pub. No.: US 2013/0184878 A1
(43) Pub. Date: Jul. 18, 2013

(54) Systems and Methods for Tracing Nodes in an Electrical Network

(71) Applicants: Ramon Juan San Andres, Atlanta, GA (US); Atul Nigam, Atlanta, GA (US)

(72) Inventors: Ramon Juan San Andres, Atlanta, GA (US); Atul Nigam, Atlanta, GA (US)

(73) Assignee: General Electric Company, Schenectady, NY (US)

(21) Appl. No.: 13/350,279

(22) Filed: Jan. 13, 2012

(51) Int. Cl. G06F 1/26

(52) U.S. Cl. 700/286

(57) ABSTRACT

Systems and methods for tracing nodes in an electrical network to, among other things, extract information from such nodes is disclosed. Such tracing can include a single, generic tracer software module that can communicate with one or more objective modules associated with each node or piece of equipment in the electrical network to implement the features described in embodiments herein.

### FIELD OF THE INVENTION

Embodiments herein relate generally to electrical networks and more particularly to systems and methods for tracing nodes in such networks.

### BACKGROUND

Computer software for power systems can be used to operate on information from nodes or equipment in an electrical network. The collection of such information commonly requires performing multiple traces on the network to collect various types of information about the network or to perform certain actions on individual nodes in the network. Each of these multiple traces may be accompanied by a different set of requirements, which may require software developers to create different methods associated with each purpose of a trace. Creating different methods can be inefficient and implementing them can be suboptimal for code performance and reuse, among other things.

### SUMMARY

Some or all of the above deficiencies may be addressed by certain embodiments described herein. Certain embodiments may include systems and methods for collecting information from electrical networks via a tracer. According to one embodiment of the invention, there is disclosed a system operable to trace an electrical network, generate an objective for each node in the electrical network, store a result of the trace in the objective for each node, and retrieve the result of the trace from the objective of each node.

According to another embodiment of the invention, there is disclosed a method which includes tracing an electrical network, generating an objective for each node in the electrical network, storing a result of the tracing in the objective for each node, and retrieving the result of the tracing from the objective of each node.

According to a further embodiment, there is disclosed one or more computer-readable media storing computer-executable instructions that, when executed by at least one processor, perform operations including recursively tracing an electrical network using a generic depth-first tracer method, generating an objective object for each node in the electrical network, storing a result of the tracing in the objective object for each node, and, upon completion of the recursive tracing, retrieving the result of the tracing from the objective object.

Other embodiments, systems, methods, and features of the invention will become apparent to those skilled in the art from the following detailed description, the accompanying drawings, and the appended claims.

### BRIEF DESCRIPTION OF THE FIGURES

The detailed description is set forth with reference to the accompanying drawings, which are not necessarily drawn to scale. The use of the same reference numbers in different figures indicates similar or identical items.

FIG. 1 is a block diagram of an illustrative electrical network, to which a computer device having in its memory software for tracing the electrical network is connected.

FIG. 2 is a block diagram of a computing environment showing an illustrative system in which tracing of an electrical network can be implemented, according to one embodiment.

FIG. 3 is a flow diagram illustrating details of a method for tracing an electrical network, according to one embodiment.

### DETAILED DESCRIPTION

Illustrative embodiments will now be described more fully hereinafter with reference to the accompanying drawings, in which some, but not all embodiments of the invention are shown. The invention may be embodied in many different forms and should not be construed as limited to the embodiments set forth herein; rather, these embodiments are provided so that this disclosure will satisfy applicable legal requirements.

Illustrative embodiments of the invention are directed to, among other things, tracing of an electrical network. Tracing of an electrical network refers generally to the collection of information from nodes, e.g., equipment, in an electrical network. Such tracing can be performed by a tracer. A tracer refers generally to a software method or class that includes generic program code for performing a trace, i.e., tracing. Embodiments herein are directed to a single, generic tracer that can be associated with one or more objectives that contain program code that is separate from the program code in the tracer method. Objectives can include program code that is directed to managing and performing tracing for particular nodes or equipment in an electrical network. Thus, like a tracer, an objective can be a software method or class but may contain more specific program code and information tailored for each node in the electrical network. As used herein, an objective may also be referred to as an “objective object,” “objective method,” or an “objective instantiation module.”

Exemplary embodiments herein relate to a tracer that includes program code that is separate from that found in one or more objectives. According to these embodiments, the tracer may be invoked once to handle various software requests, such as requests from power system software to extract information from an electrical power network. Each of the software requests can involve a trace of the nodes or equipment in an electrical network to extract the information. A single invocation of the tracer can communicate with instances of objectives to implement the requested traces. In one embodiment, such communication can occur via an application programming interface (API) in which the tracer calls methods or functions to request certain actions from each of the objectives. For example, a tracer may call methods in the API to instantiate or create an instance of an objective for communication with a respective node or piece of equipment in an electrical network. In one embodiment, a standard common interface model (CIM)-based API can be used to, for example, enable communication between a tracer and objectives in CIM-based networks.

In the way that an objective is associated with a particular node, the objective can make various determinations for its respective node, such as the behavior of the tracing (i.e., which nodes or equipment are traced), the activities to be performed during the tracing (i.e., what actions are performed at each node, what results are expected from the trace, and how the results collected during the trace are accumulated), and the resulting information that can be collected after the tracing is complete.

The technical effects of certain embodiments disclosed herein may include simplification of tracer logic and optimization, better facilitation of testing and maintenance of nodes in the electrical network, and the reuse of existing code, as examples. For example, program code located in the tracer method does not have to exist in each objective method. In this way, the amount of redundant code may be reduced, which also may prevent repeated execution of such code with each trace.

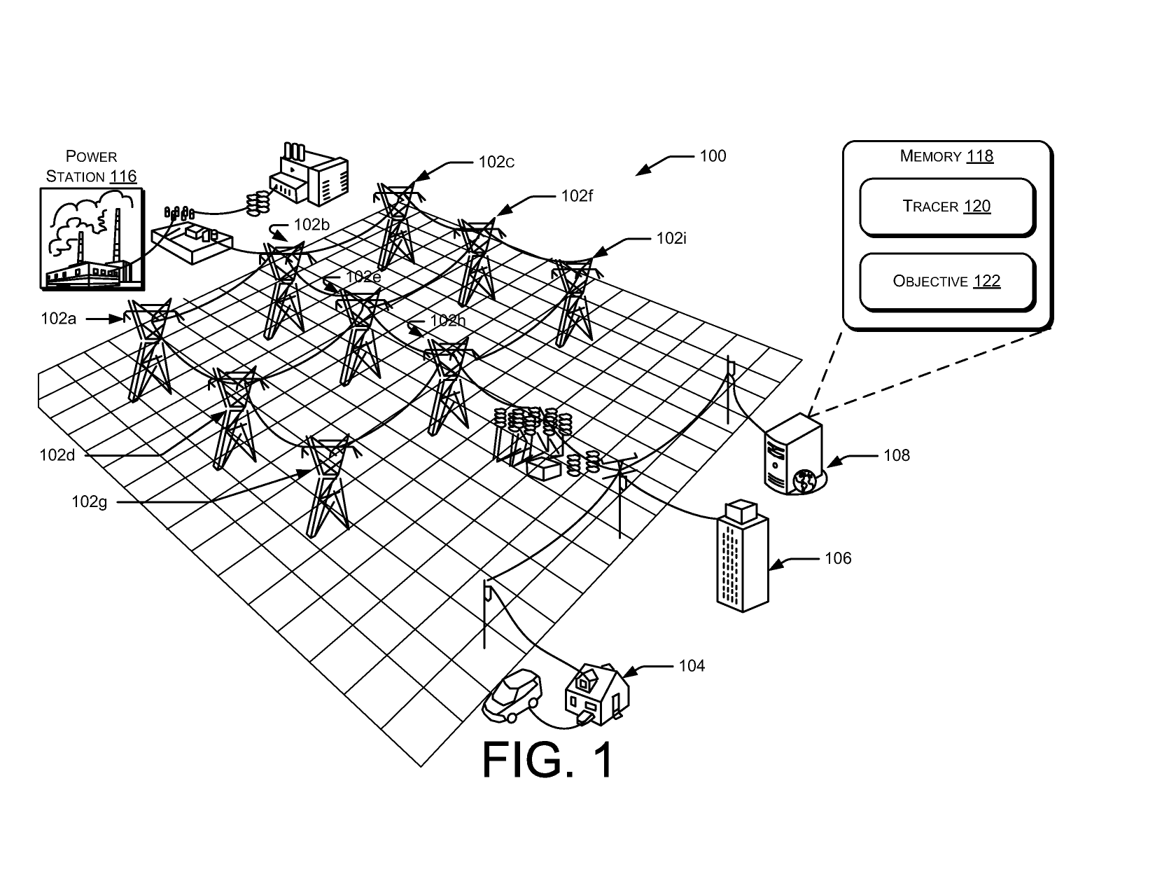

FIG. 1 depicts an exemplary electrical network, an electric power network 100. The electric power network 100 includes distribution feeders 102a-i for distributing electric power generated by power station 116 to various locations, such as a home 104, a building 106, or other facilities. In one embodiment, each distribution feeder 102a-i represents a node in the electric power system 100. In an exemplary embodiment, the electric power network 100 is based on a CIM, which is an open standard that defines how managed elements in a network are represented as a common set of objects and the relationships between those objects. Embodiments herein can also relate to various other types of electrical networks, such as those that are non-CIM-based.

FIG. 1 also depicts a computer device 108, which can communicate with the electric power network 100. Such communication can occur via a wired connection, or additionally or alternatively via a wireless connection, according to some embodiments. The computer device 108 can include a memory 118, which can include a tracer 120 and an objective 122. Although only one objective 122 is shown in the memory 118, multiple objectives may exist. The tracer 120 can communicate with each of the multiple objectives via an API, according to some embodiments. In one embodiment, each objective can be associated with one of the nodes 102a-i. Additionally, each objective can be associated with children of the nodes 102a-i. Each objective 122 can manage and perform a trace for its associated node such that different information can be extracted for each node. A trace can be implemented on various types of computer devices 108. For example, a personal computer, mainframe, web server, or mobile device may be configured to implement such processes.

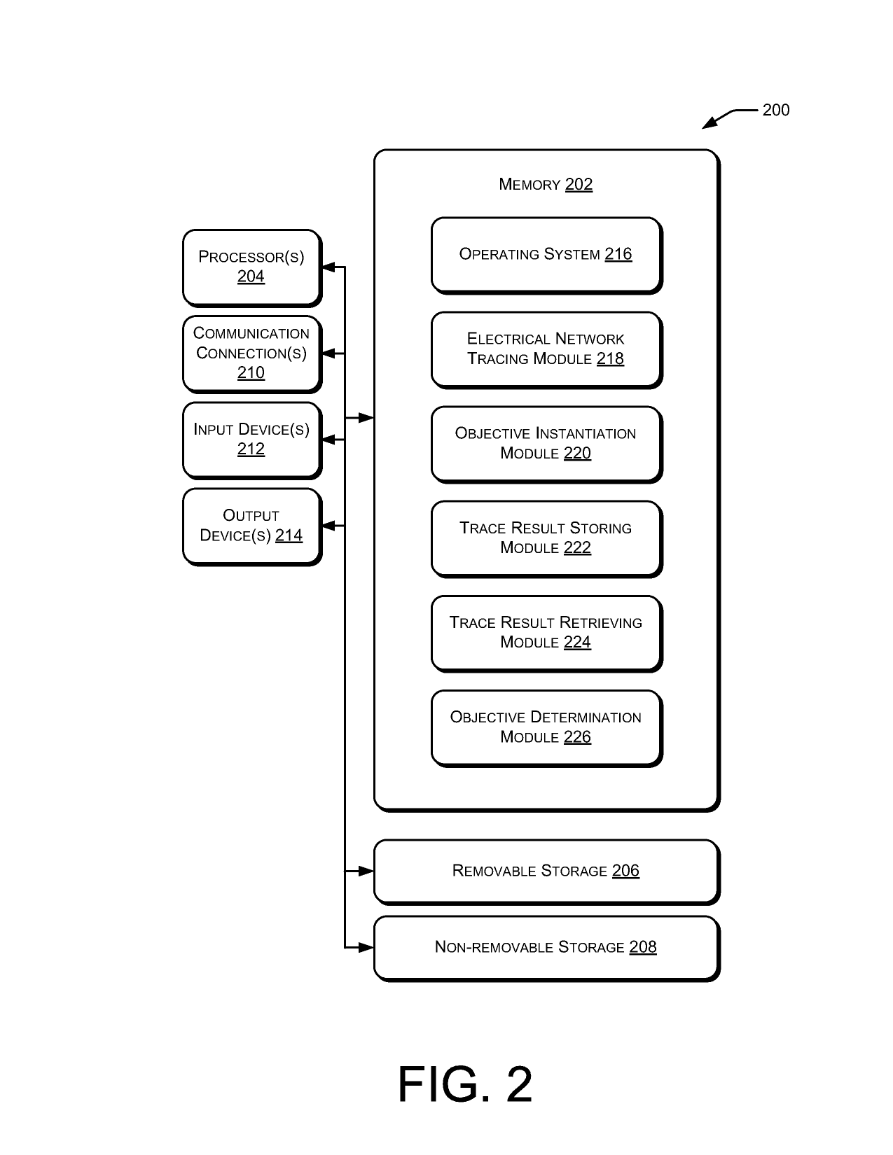

FIG. 2 depicts a block diagram of an exemplary computing environment 200 in which tracing of an electrical network can be implemented. The computing environment 200 can include a computing device, e.g., computer device 108, which can include a processor 204 capable of communicating with a memory 202. The processor 204 may be implemented as appropriate in hardware, software, firmware, or combinations thereof. Software or firmware implementations of the processor 204 may include computer-executable or machine-executable instructions written in any suitable programming language to perform the various functions described.

A memory 202 may store program instructions that are loadable and executable on the processor 204, as well as data generated during the execution of these programs. Depending on the configuration and type of computing environment 200, a memory 202 may be volatile (such as random access memory (RAM)) and/or non-volatile (such as read-only memory (ROM), flash memory, etc.). The computer device 108 may also include additional removable storage 206 and/or non-removable storage 208 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 202 may include multiple different types of memory, such as static random access memory (SRAM), dynamic random access memory (DRAM), or ROM.

The memory 202, removable storage 206, and non-removable storage 208 are all examples of computer-readable storage media. For example, computer-readable storage media may include volatile and non-volatile, removable and non-removable media implemented in any method or technology for storage of information such as computer-readable instructions, data structures, program modules or other data. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can accessed by the computer device 108 or another computing device. Combinations of any of the above should also be included within the scope of computer-readable media.

In other embodiments, however, computer-readable communication media may include computer-readable instructions, program modules, or other data transmitted within a data signal, such as a carrier wave, or other transmission. As used herein, however, computer-readable storage media does not include computer-readable communication media.

The computing environment 200 may also contain one or more communication connections 210 that allow the computer device 108 to communicate with nodes 102a-i and other equipment in the electric power network 100 having network connectivity. The computing environment 200 may also include one or more input devices 212, such as a keyboard, mouse, pen, voice input device, and touch input device. It may also include one or more output devices 214, such as a display, printer, and speakers.

Turning to the contents of the memory 202 in more detail, the memory 202 can include an operating system 216 and one or more application programs or services for implementing the features and aspects disclosed herein, including an electrical network tracing module 218, an objective instantiation module 220, a trace result storing module 222, a trace result retrieving module 224, and an objective determination module 226.

The electrical network tracing module 218 can perform generic tracing functions for an electrical network, such as the electric power network 100. Such functions may be generic in the way that non-specific actions, i.e., those actions that are not particular to a node or piece of equipment in the electrical network, may be performed. In one embodiment, the electrical network tracing module 218 embodies the tracer 120 shown in FIG. 1.

The electrical network tracing module 218 can be a singleton object that can be shared by various software to perform generic functions related to tracing an electrical network. According to this configuration, the electrical network tracing module 218 may be invoked once while the objective instantiation module 220, with which it can communicate, may be invoked for each node in an electrical network. As an example, various software can recursively call the electrical network tracing module 218 and, as a result, invoke the directives of the objective instantiation module 220 to trace an electrical network. According to this configuration, the electrical network tracing module 218 does not maintain state information. Such information may be instead maintained in the objective instantiation module 220 to facilitate the particularized processing of each node or piece of equipment in an electrical network. In one embodiment, the electrical network tracing module 218 receives three parameters: an objective, a node, and a direction. More particularly according to this embodiment, the tracing module 218 traces an electrical network beginning at a specific node or piece of equipment (i.e., node parameter) in a specified direction (i.e., direction parameter) using a particular objective (i.e., objective parameter).

As noted above, the electrical network tracing module 218 can communicate with the objective instantiation module 220 via an interface, such as a standard, CIM-based API. In one embodiment, such communication can be enabled using the Java programming language. The Java programming language can also be used to develop the methods and functions described herein. Various other programming languages may be used in other embodiments, such as C++, Perl, and other object-oriented programming languages, for example.

Each instance of an objective instantiation module 220 can manage and perform traces in an electrical network instead of the electrical network tracing module 218, according to one embodiment. Although only one objective instantiation module is shown, many more may exist in other embodiments. For example, each node in an electrical network can be traced using a separate instance of the objective instantiation module 220. The objective instantiation module 220 can determine the behavior of the tracing, such as which nodes will be traced. Such a determination can be made by a node's properties and characteristics and/or the objective instantiation module 220's guidelines and state. Characteristics of nodes may include the type of node, such as a transformer winding, a switch, or a power consumer. Characteristics of the objective module 220 may include the purpose of the objective, such as to accumulate the total energy consumption of all power consumers within a particular section of the network, or to determine the energization status of all the line segments in the network.

The objective instantiation module 220 can also determine the activities to be performed during the tracing, such as the actions to be performed at each node, the results that are expected from the trace, and the manner in which retrieved information is accumulated. The actions to be performed at each node may include specifying values in network nodes (e.g. energization states), reporting certain conditions, and creating alternative representations of the network. Results that are expected from the trace may include energization state, power usage, fault status, fault impedance values, or any other information specified for collection in an objective instantiation module. The manner of accumulation may depend on the type of information extracted from nodes in the electrical network and may include various mathematical operations performed on the information collected from the nodes. In one embodiment, the above determinations made by the objective instantiation module 220 can be implemented by an objective determination module 226, also residing in the memory 202.

In one embodiment, the objective instantiation module 220 may include methods that are executed at certain intervals associated with a trace. For example, various methods may be executed before and after performing an actual trace, i.e., pre- and post-trace methods. Additional methods may also be executed before and after the pre- and post-trace methods. According to this embodiment, a base class or objective may implement the pre- and post-trace methods such that classes derived from the base class do not have to implement these methods. According to this embodiment, derived classes may, however, implement the methods performed before and after the pre- and post-trace methods. Thus, like the electrical network tracing module 218, the objective instantiation module 220 may be developed in a way that reduces the amount of redundant code and optimizes execution of the code. The methods in the objective instantiation module 220 may be executed at various other intervals in other embodiments.

An exemplary objective instantiation module 220 can be one that implements the calculation and retrieval of circuit loads, estimation of the number of customers within a circuit area, retrieval of circuit equipment based on certain specified characteristics (e.g., all open switches in an electrical network), and location of network faults using fault impedance values and fault indicators.

FIG. 2 also depicts a trace result storing module 222 and a trace result retrieving module 224. The trace result retrieving module can collect trace results from each node and/or any of that node's children that may be subjected to a trace. Such results can be stored in an objective instantiation module 220 associated with each node by the trace result storing module 222.

While the embodiment in FIG. 2 describes a computer device with a memory 202 including various modules, one will recognize that certain functionality associated with the computer device can be distributed to any number and combination of computer or processor-based devices in accordance with other embodiments. Various instructions, methods, and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environments. Typically, the functionality of the program modules may be combined or distributed as desired in various embodiments. An implementation of these modules and techniques may be stored on some form of computer-readable storage media.

The exemplary electrical network 100 shown in FIG. 1 and the exemplary computing environment 200 shown in FIG. 2 are provided by way of example only. Numerous other electrical networks, computing environments, and configurations are possible. Accordingly, embodiments herein should not be considered as being limited to any particular network, environment, or configuration, or otherwise limiting in any other way.

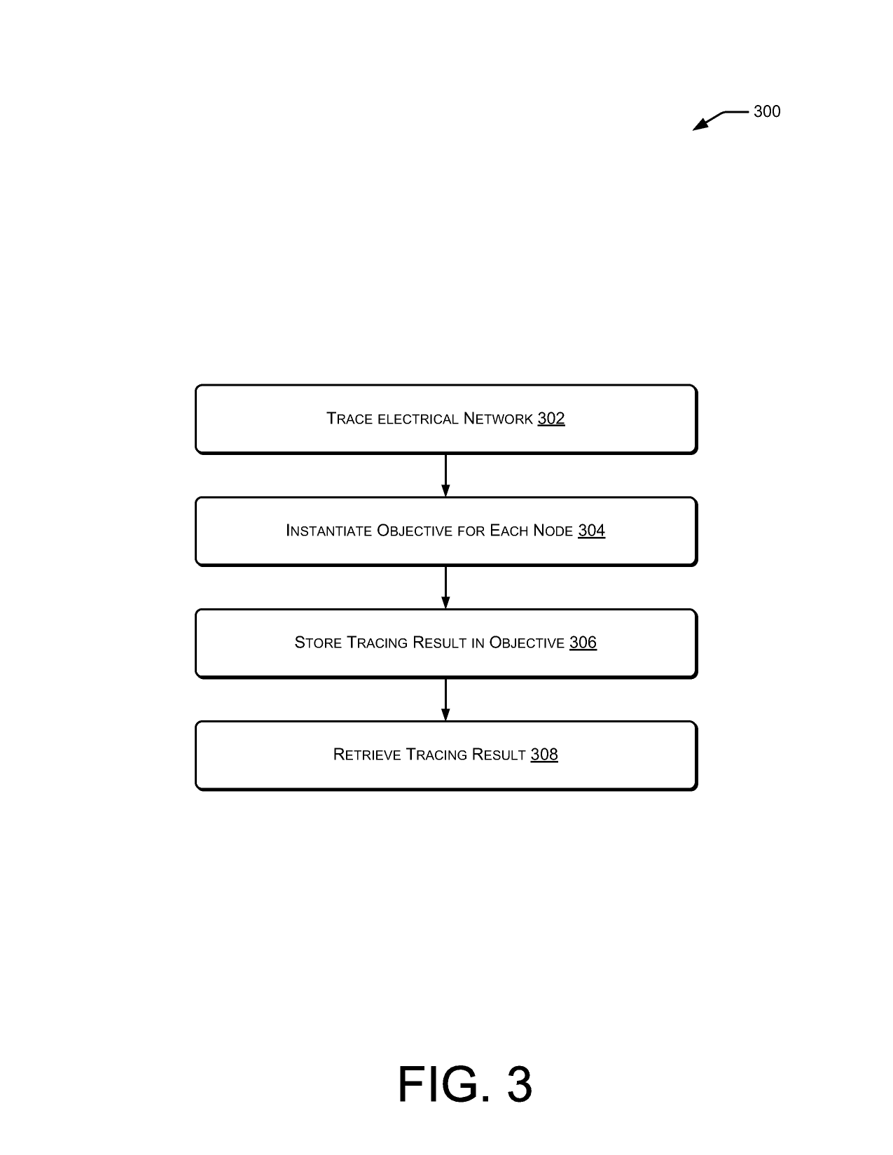

FIG. 3 is an exemplary flow diagram illustrating details of a method for tracing an electrical network. In one example, the computing device 108 can perform any, some, or all of the operations of process 300. The process 300 is illustrated as a logical flow diagram, in which each operation represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

In this particular implementation, the process 300 can begin at block 302, where an electrical network is traced. As noted above, a single, generic objective can be used to trace one or more nodes in the electrical network. Additionally or alternatively, an objective can trace the children of nodes in the electrical network. To accomplish tracing of each individual node, according to one embodiment, an objective can be instantiated for each node (i.e., block 304). Each objective can implement different requirements for the one or more nodes with which it is associated.

The trace performed at block 302 can be implemented by a generic, depth-first tracer, according to one embodiment. A depth-first tracer can perform a trace by starting at a particular node and exploring as far as possible along branches of an electrical network before backtracking. As noted above, such a tracer may be referred to as generic because particular logic for performing a trace may be implemented by an objective, such as the objective instantiation module 220 shown in FIG. 2. For example, the specification of a depth-first tracer can be specified in an objective instantiation module 220. Various other directions or types of tracers, i.e., other than depth-first, can be specified and implemented in other embodiments.

As noted above, a trace can also be performed by a singleton object with generic tracing capabilities. In the way that a singleton object may be invoked once by software requesting information from an electrical network, for example, the singleton object can be shared by various software requesting a trace and associated information. According to this configuration, the singleton object can have generic tracing capabilities while more specific capabilities are specified in objective instantiation modules associated with each node to be traced in the electrical network. In this way, the trace is based at least in part on the objective.

In an exemplary embodiment, the trace method does not return a value, e.g., information related to a node, at the completion of block 302. According to this embodiment, an objective instantiation module can retrieve the results gathered during the trace from its associated node and/or children nodes, e.g., via the trace result retrieving module 224, at block 308, and the tracing results for a node and its associated children can be stored in an objective instantiation module at block 306, e.g., via the trace result storing module 222.

Illustrative systems and methods for tracing an electrical network are described above. Some or all of these systems and methods may, but need not, be implemented at least partially by configurations such as those shown in FIGS. 1 and 2. It should be understood that certain acts in the methods may be rearranged, modified, and/or omitted entirely, depending on the circumstances. Also, any of the acts described above with respect to any method may be implemented by any number of processors or other computing devices based on instructions stored on one or more computer-readable storage media.

That which is claimed:

1. A system, comprising:
at least one memory that stores computer-executable instructions;
at least one processor configured to access the at least one memory, wherein the at least one processor is configured to execute the computer-executable instructions to:
trace an electrical network;
generate an objective for each node in the electrical network;
store a result of the trace in the objective for each node; and
retrieve the result of the trace from the objective of each node.

2. The system of claim 1, wherein the trace is performed by a generic depth-first tracer.

3. The system of claim 1, wherein the trace is performed by a singleton object with generic tracing capabilities.

4. The system of claim 1, wherein the trace is performed by a tracer method with parameters comprising objective, node, and direction.

5. The system of claim 1, wherein the trace is performed based at least in part on the objective.

6. The system of claim 1, wherein the trace is performed by a tracer method that does not return a value.

7. The system of claim 1, wherein the objective determines at least one of:
a behavior of the trace;
an activity to be performed during the trace; or
information that will be available upon completion of the trace.

8. The system of claim 7, wherein the behavior of the trace comprises equipment to be traced.

9. The system of claim 7, wherein the activity to be performed comprises at least one of an action performed at each network element, a result returned from the trace, or a manner of retrieved information accumulation.

10. A method, comprising:
tracing an electrical network;
generating an objective for each node in the electrical network;
storing a result of the tracing in the objective for each node; and
retrieving the result of the tracing from the objective of each node.

11. The method of claim 10, wherein the tracing is performed by a generic depth-first tracer.

12. The method of claim 10, wherein the tracing is performed by a singleton object with generic tracing capabilities.

13. The method of claim 10, wherein the tracing is performed by a tracer method with parameters comprising objective, node, and direction.

14. The method of claim 10, wherein the tracing is performed based at least in part on the objective.

15. The method of claim 10, wherein the tracing is performed by a tracer method that does not return a value.

16. The method of claim 10, wherein the objective determines at least one of:
a behavior of the tracing;
an activity to be performed during the tracing; or
information that will be available upon completion of the tracing.

17. The method of claim 16, wherein the behavior of the tracing comprises equipment to be traced.

18. The method of claim 16, wherein the activity to be performed comprises at least one of an action performed at each network element, a result returned from the trace, or a manner of retrieved information accumulation.

19. One or more computer-readable media storing computer-executable instructions that, when executed by at least one processor, perform operations comprising:
recursively tracing an electrical network using a generic depth-first tracer method;
generating an objective object for each node in the electrical network;
storing a result of the tracing in the objective object for each node; and
upon completion of the recursive tracing, retrieving the result of the tracing from the objective object.

20. The one or more computer-readable media of claim 19, wherein the objective determines at least one of:
a behavior of the tracing;
an activity to be performed during the tracing; or
information that will be available upon completion of the tracing.
